(19) United States
(12) Patent Application Publication
(10) Pub. No.: US 2017/0024779 A1
(43) Pub. Date: Jan. 26, 2017

(54) COMPUTER-IMPLEMENTED METHOD FOR ONLINE DELIVERY OF ADVERTISING CONTENT

(71) Applicant: Vertamedia LLC, Las Vegas, NV (US)

(72) Inventors: Vasyl Nikolaiev, Kherson (UA); Iurii Gorokhov, Odessa (UA)

(21) Appl. No.: 15/236,042

(22) Filed: Aug. 12, 2016

(51) Int. Cl. G06Q 30/02; H04L 29/08

(52) U.S. Cl. CPC G06Q 30/0277; H04L 67/18; H04L 67/22; H04L 67/327; G06Q 30/0261

(57) ABSTRACT

The approach disclosed herein relates to online advertising. More particularly, the disclosed computer-implemented methods for online delivery of advertising content allow to optimize and enhance efficiency of advertising campaigns by more accurate selection of advertising playback responses.

The computer-implemented methods for online delivery of advertising content disclosed herein aims to improve upon random search of advertising unit playback responses or human assessment methods and enable a more accurate selection of advertising unit playback responses for incoming advertising unit playback requests using a special server executable algorithm. This algorithm also allows to significantly reduce the time when the server receives a specific advertising unit playback request and the Advertiser platform makes a decision on playback or rejects a playback which increases the total number of positive decisions on advertising unit playbacks and efficiency of the server.

### FIELD OF THE INVENTION

The approach disclosed herein relates to online advertising. More particularly, the disclosed computer-implemented methods for online delivery of advertising content allow to optimize and enhance efficiency of advertising campaigns by more accurate selection of advertising playback responses.

### BACKGROUND OF THE INVENTION

### Definitions

It is advantageous to define several terms before describing the invention. Thus, the following terms used throughout this disclosure, are defined as follows:
“Publisher”—hardware/software platform designed to enable advertising playback or to make a decision on advertising playback in visual, audio, graphic, and/or text form (“Advertisement”) in designated location on user's device (see also “Ad Placement” below),
“Advertiser”—hardware/software platform designed to enable delivery of data in visual, and/or audio, and/or graphic, and/or text form to user's device.
“Server”—hardware/software platform for data exchange between Publisher and Advertiser for Advertisement delivery.
“Advertising Playback Request” or “Ad Request”—data from Publisher platform incoming to Server.
“Advertising Playback Response” or “Ad Response”—data from Advertiser platform incoming to Server.
User's Device—computer with display unit, CPU, storage device, and Internet connection used to exchange data with Publisher platform and capable of playing back advertising units on video player or on any other visual, audio, graphic, or text software.
Advertising unit—advertising data in visual, audio, graphic, and/or text form.
Ad Placement—part of graphic interface for playback of advertising units on user's device.

Online advertising means the use of advertising network in form of a computer system including at least one server that accepts advertising unit playback requests from Publisher platform and advertising unit playback responses. The server receives advertising unit playback requests that may be missing any advertising unit playback response selection criteria or may have a limited choice of the criteria, such as user's device location or advertising unit display cost.

The Advertiser platform makes decisions on playback of an advertising unit for specific advertising unit playback request. As a result, a specific advertising unit is played back on user's device or rejected. The decision is made basing on certain amount of collected data that include User-Publisher session interaction parameters, such as video player size, browser and/or operation system used during session, location of user's device, etc. The above parameters can be partly used in different combinations or replaced by other parameters basing on specific advertising unit playback response.

This means that the server performs the search of received advertising unit playback responses, selects a specific response optimal for the specific advertising unit playback request and sends this request to the Advertiser platform that makes a decision on playback of the advertising unit or rejects it if this request doesn't meet the selection criteria set by the Advertiser platform. The server should perform the search and choose a response within advertising unit playback request's limited timeout. In case advertising unit playback response selection criteria are missing, the server has to choose a random advertising unit. Even in case of eligible choice of criteria, the server as a rule performs search basing on subjective assessment, server operator's, for instance. This results in almost blind selection of campaigns made within advertising unit playback request's limited timeout which, in turn, results in low efficiency of online advertising campaigns.

The following known calculation or prediction methods are used to solve the problem of optimal selection of advertising unit playback response to send an advertising unit playback request from the server to the Advertiser platform or server learning methods to increase the speed of making a best decision on sending such request basing on previously collected server data.

There is a known optimization method of advertising unit playback request selection that uses prediction engines described in U.S. Pat. No. 7,908,238 B1. The above method involves creation of a probabilistic tree consisting of multiple units each including data on total number of attempts and positive decisions, while at least one unit associated with computed predicted probable speed of response to the published demand and/or supply data.

There is also a computer-based real-time advertising unit playback optimization method of creating a probabilistic tree consisting of multiple units associated with advertising unit playback responses and online bidding among advertising unit playback responses associated with the above probabilistic tree of nodes, described in US2014337125 A1. The biddings allow to get desired number of successful playbacks and stay within the campaign's budget on which the request selection criteria and criteria for choosing specific user's device for which the advertising unit playback request was received is based. To select a set of appropriate nodes, a target set of nodes that meets the response selection criteria shall be determined; playback for each target node shall be predicted, the target nodes of the specified set shall be ranked and filtered, based at least partly on the predicted advertising unit playback data for each target node.

Also known is to select online advertising unit playback response based on predicted time of existence of a request that involves bidding. Such known methods enable a server to receive both advertising unit playback response data and advertising unit playback request data. The received data contain per time advertising unit playback cost. The response data contain target group data and target media content information. Identification of specific user's device to playback advertising units shall be made basing on advertising unit playback request timeout. This time is determined by machine learning methods using user data attributes, content, and advertising unit display time received by the server. To select a specific response or create a list of most relevant responses, an online bidding of qualified responses is used which bases on certain advertising unit playback request timeout. One such known method is described in US2015332331 A1, in which, in order to build an optimal request processing queue, the predicted timeout request response timeout is used for each advertising unit playback response and ranking of received data based on the budget for the advertising unit playback responses.

### SUMMARY OF THE INVENTION

Generally, the invention disclosed herein aims to improve upon random search of advertising unit playback responses or human assessment methods and enable a more accurate selection of advertising unit playback responses for incoming advertising unit playback requests using a particular server-executable algorithm. This algorithm also allows to significantly reduce the time when the server receives a specific advertising unit playback request and the Advertiser platform makes a decision on playback or rejects a playback which increases the total number of positive decisions on advertising unit playbacks and efficiency of the server.

In its various embodiments and implementations, the invention contemplates at least some of the following steps:
receiving of advertising unit playback request data by at least one server using data exchange protocol that supports visual, audio, graphic and/or text information;
receiving of advertising unit playback response data containing advertising unit playback request selection criteria;
comparing, at a server, of advertising unit playback request data and received advertising unit playback request selection criteria;
generating, at the server, of polling order of the Advertiser platforms from which advertising unit playback response data were received;
polling, at the server, of the Advertiser platforms from which advertising unit playback response data were received according to the generated polling order;
receiving by the server of advertising unit playback confirmation data;
performing playback of confirmed advertising unit on user's device using data exchange protocol that supports visual, audio, graphic and/or text information; the method also enables additional functionality:
performing primary server filtering of each advertising unit playback request basing on location of user's device and/or on the limit number of advertising unit playbacks for each Ad Placement and generation of a list of advertising unit playback requests that conform location of user's device and/or limit number of advertising unit playbacks;
collecting by the server of processing results of advertising unit playback request data:
   total number of advertising unit playback requests (Requests);
   number of playbacks of advertising unit (Impressions);
   number of rejected of advertising unit playbacks (Errors);
calculating ranking rate for each advertising unit playback response for received request basing on the following equation:

Performance=TTE+FillRate÷CPM
Performance—ranking rate for specific advertising unit playback response;
TTE—time from ad response to the event, namely the event of advertising unit playback on user's device (Impression) or to the event of receiving of advertising unit playback rejection data on all processed server requests associated with specific advertising unit playback (Error).
FillRate—advertising unit playback/request ratio.
CPM—cost of 1000 advertising unit playbacks,
The FillRate is calculated by the following equation:

FillRate=Impressions÷Requests
ranking by the server of advertising unit playback responses basing on the Performance calculated above, from minimum ranking rate responses to maximum ranking rate responses;
performing playback of advertising unit on user's device for the response with the lowest ranking rate; and
performing playback of advertising unit with higher ranking rate response when the playback of advertising unit with previous ranking rate is rejected.

According to one of embodiment of the disclosed method, the results of processing of requests sent from the server to devices from which the advertising unit playback response data were received, include the following data: video player size, user's browser, user's operation system and/or location of user's device.

Another embodiment of the disclosed method provides for sorting of the results of processing of advertising unit playback requests collected by the server by time intervals, for example, 1, 5, 20, 60, 180 and 360 minutes, from the time the server has received advertising unit playback request data from user's device.

In accordance with another embodiment of the disclosed method, when calculating ranking rate for each advertising unit playback response for received request, the specified data for the lowest time interval are used first followed by the data from the next time intervals providing that the amount of data is lower than the amount preset for the previous time interval.

Another embodiment of the method provides for receiving of advertising unit playback request data by the server and playback of advertising unit on user's device through data exchange protocol, such as VAST or VPAID API framework.

These and other features and advantages, which characterize the present non-limiting embodiments, will be apparent from a reading of the following detailed description and a review of the associated drawings. It is to be understood that both the foregoing general description and the following detailed description are explanatory only and are not restrictive of the non-limiting embodiments as claimed.

### BRIEF DESCRIPTION OF THE DRAWINGS

Non-limiting and non-exhaustive embodiments are described with reference to the following figures in which:

FIG. 1 represents a diagram denoting all elements of the system used for the implementation of the proposed method;

FIG. 2—general arrangements diagram of the Ad-network system used for the implementation of the proposed method, wherein 1 is advertising unit playback request data (Ad Request); 2 is Advertising unit playback response data from the Advertiser platform (Ad Response).

FIG. 3—online advertising optimization server algorithm diagram, wherein Publisher's web site is example of an element of the Publisher's hardware/software platform; Formula is an empirical equation for a calculation of the performance, mentioned below.

### DETAILED DESCRIPTION

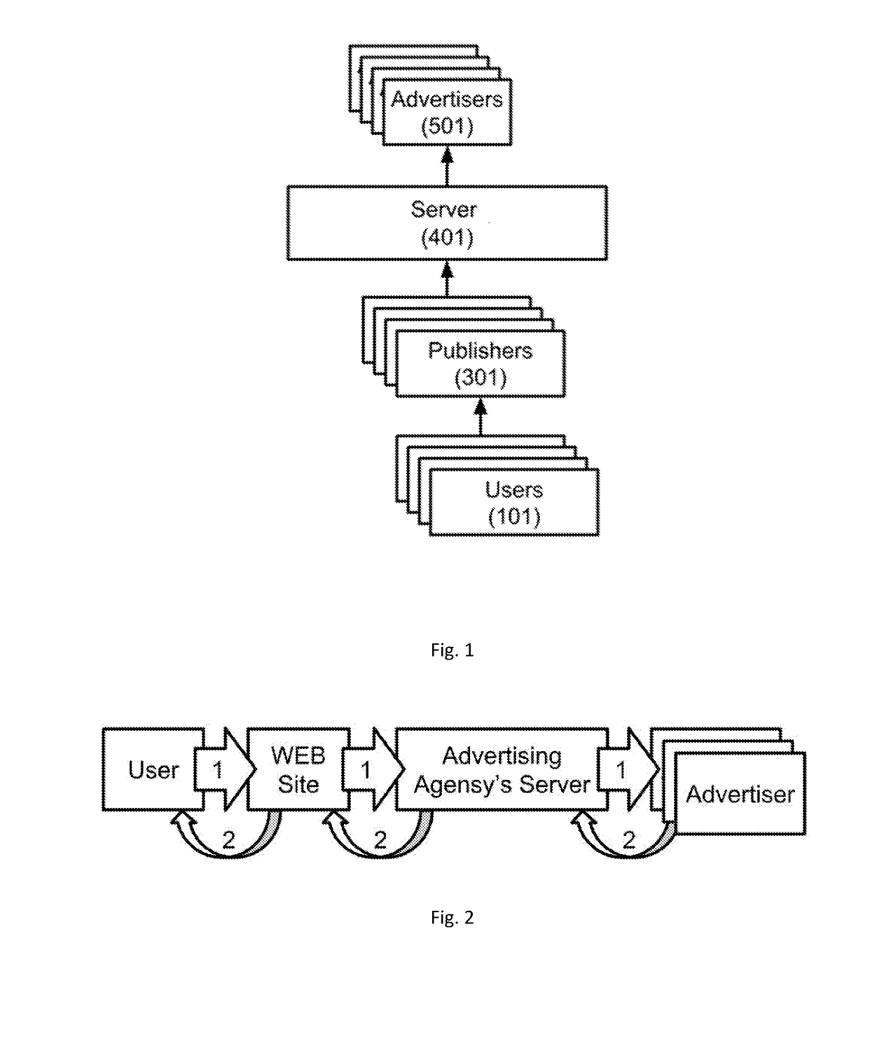

Referring to FIG. 1, in various embodiments, the system suitable for implementing the disclosed method includes a server (401) connected with a Publisher platform (301) on one part and an Advertiser platform (501) on the other part. The server (401) includes CPU, RAM and ROM, operation system and network connection interface, and a data exchange software as per appropriate protocols such as VAST or VPAID API framework. The server (401) has a programming module that enables implementation of the disclosed method when it interacts with other system elements. The Publisher (301) and Advertiser platforms can be an array of independent servers that exchange data via the Internet both between each other and with the server (401).

The Publisher platform (301) for example can include a web server or an array of web servers used by user's device (101) to get access to the Publisher (301). Digital Video Ad Serving Template (VAST) described on http://www.iab.com/guidelines/digital-video-ad-serving-template-vast-3-0 or Video Player-Ad Interface Definition (VPAID) (see https://www.iab.com/wp-content/uploads/2015/06/VPAID_2_0_Final_04-10-2012.pdf) can be used as standard protocols.

The server (401), Publisher (301), Advertiser (501) and data exchange network create the above Ad-network.

The user's device (101) can be PC, tablet, smartphone, mobile, TV with Internet connection, etc.

The online advertising method based on the above system is implemented as follows. As mentioned above, a user (101) requests access to the Publisher, e.g. by opening a web page or launching a game app on his/her user's device. This initiates sending of an advertising unit playback request from the user's device (101) to the server (401) via visual, audio, graphic and/or text playback software using Internet data exchange protocol, e.g. VPAID. The playback software means an appropriate software deployed on the user's device (101), e.g. a browser based video player used by the user to access web sites. Another software example is a game app installed on user's device or a game app with online access.

The server (401) is also connected to a database where advertising unit playback responses from at least one Advertiser (501) are stored. The received advertising unit playback response data make up one campaign at the minimum.

Then using the above programming module a campaign is selected on the server (401) and the advertising unit playback request is passed on to the Advertiser (501), e.g. to the device which has been used to send the advertising unit playback response data.

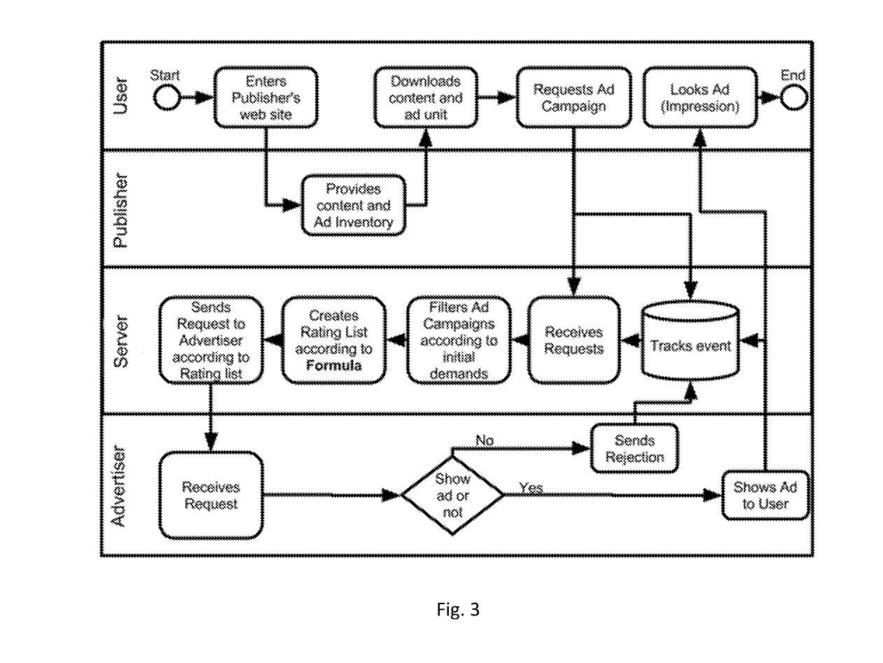

Referring to FIG. 3, the disclosed method based on using the server (401) with online advertising optimization module is executed as follows.

After the server (401) has received an advertising unit playback request data from the Publisher (301) and before this request is processed by the server (401) to make decision on selection of Advertiser's response, the above request is filtered by the server (401). The primary filtering (hard matching) is done by checking if the received advertising unit playback response data meet request selection criteria the server (401) received from the Advertiser (501). These criteria are the location of the user's playback device (101) and the preset limit number of playbacks. The latter requires comparing of preset playbacks for the specified time (say month, etc.) and actual playbacks generated by the Publisher (301). If advertising unit playback request data are not true to any of these parameters, e.g. the user's device (101) is not located in any specific country or region or the Publisher (301) has exceeded the limit number of playbacks, such a request undergoes filtering resulting in a request list on the server (401) that meets the above criteria to continue polling devices from which the advertising unit playback response data were received.

Following primary filtering of a specific advertising unit playback request, this request is processed in the server's (401) programming module to optimize online advertising. To do this, the statistics on positive and negative decisions made by the Advertiser (501) based on preset parameters is collected on the server (401). In case the user's device (101) accesses a web site, e.g. to open a web page in browser, the following parameters can be used: Publisher's source, domain, video player size, and campaign at different preset time intervals, e.g. in the last 1, 5, 20, 40, 60, 180 and 360 minutes from the moment the server (401) got an advertising unit playback request from the user's device (101). The positive decision means a playback decision as per request for specific user's device (101). The negative decision is an error as per request for specific user's device (101).

The data collected on the basis of the above parameters include the following data of each time interval:
total number of advertising unit playback requests,
total number of playbacks after receiving a request,
number of rejected playbacks.

The advertising unit playback request is then analyzed for its conformity to a few of active Advertiser campaigns whose data have been received by the server (401). Selection of campaigns is done through processing of the above statistics basing on empirical dependence. In the result a campaign ranking (rating) is created—from the most attractive (lowest ranking rate) to the least profitable (highest ranking rate) campaign—according to specific as request, and the server (401) automatically makes a decision to send a request on specific campaign. In case of rejected playback, the next campaign in the generated ranking list is chosen and the action is repeated until positive response, i.e. until the playback is confirmed or until advertising unit playback request timeout (e.g. user leaves the web site from which the request was received, etc.).

As mentioned earlier, ranking of campaigns involves processing of statistical data collected in certain time interval, a so called cumulative sample. The statistical data collected in each time interval should be sufficiently comprehensive to enable their ranking, i.e. they should include different campaign selection criteria. When ranking, the data collected in time interval closest to the time of receiving of advertising unit playback request, e.g. within one minute, are used first as the most actual statistical data secure the best ranking result. With consideration of a set of campaign selection criteria which data should be available to make a decision, in case of lack of data in the closest time interval, a longer time interval is used, i.e. the interval that includes “older” statistical data. This enables use of data from 1, 5, 20, 60, 180 and 380 minute intervals. It is clear that the statistical data processing task is resource-intensive for the server (401) as in many cases it requires simultaneous processing of data on hundreds of Publishers (301) which may have thousands of resources from which the advertising unit playback request was received; moreover this should be done within a very short time (request timeout) that can't be predicted. In addition, each additional parameter that should be added to the specified stored and processed dataset considerably increases load on the server (401) that should automatically make the most accurate real-time decisions that affect efficiency of online advertising. To solve the problem of reducing the load on the server (401) arising during campaign ranking (advertising unit playback responses) and to increase ranking accuracy, the following empirical dependence was determined basing on collected statistical data:

Performance=TTE÷FillRate÷CPM
Performance—Ranking rate for specific advertising unit playback response;
TTE—time from ad response to the event, namely the event of advertising unit playback on user's device (Impression) or to the event of receiving of advertising unit playback rejection data on all processed server requests associated with specific advertising unit playback (Error).
FillRate—advertising unit playback ratio for all processed server (401) requests for this advertising unit;
CPM—cost of 1000 advertising unit playbacks,

The FillRate is calculated by the following equation:

FillRate=Impressions÷Requests.

The TTE value can be both an arithmetical mean and a median from time intervals collected by the server (401). This means that the median time is determined by the approaches known in mathematical statistics described, for example, in https://en.wikipedia.org/wiki/Median.

According to the above dependence, the server (401) automatically determines campaign ratings (advertising unit playback responses) for specific request and rank them per calculated Performance. The server (401) polls campaigns basing on that rating starting from the campaign (response) that has the lowest Performance. In case the server (401) receives rejected playback data for the campaign with a higher rating (lower Performance), an advertising unit playback request for the campaign with lower rating is sent (i.e. the campaign with next higher Performance), etc., until the server (401) receives data with positive decision on Impression from the Advertiser; after this the campaign received positive decision is displayed on the user's device (101).

The system described above has been tested to confirm the expected technical performance of the online advertising method with the use of the server (401) with playback optimization module. In the testing process, the system has been processing incoming advertising unit playback requests for some time for each option alternatively—both with module and without it, i.e. in typical server mode. The results are shown in Tables 1-3 below, with Table 1 listing initial test data, the Table 2 containing performance data without using the above module and the Table 3 containing performance data with using the above module. The Campaign ID shows campaign's numerical value.

TABLE 1
Initial test data for online impression optimization method
with the use of programming module installed on the server

| | Positive | | Cost of |
|---|---|---|---|
| | Response | Response | Impression |
| Campaigns | Probability | Time | of 1000 Ads |
| Cmpld | Fillrate, % | AvgTTI | CPM |
| 346 | 0.554017 | 5.670418 | 9 |
| 345 | 0.160772 | 5.328465 | 7 |
| 339 | 35.22618 | 29.32446 | 6.5 |
| 334 | 0.2849 | 16.34028 | 9 |
| 329 | 5.342903 | 101.7084 | 9 |
| 328 | 0.462963 | 12.43471 | 8 |
| 327 | 2.479339 | 11.81878 | 7 |
| 318 | 3.663793 | 21.29013 | 8 |
| 314 | 2.561624 | 31.72821 | 10.5 |
| 313 | 0.958084 | 25.23443 | 8 |
| 312 | 3.441296 | 92.91185 | 6 |
| 300 | 0.151286 | 81.29928 | 7.5 |
| 299 | 1.388889 | 39.22976 | 5 |
| 298 | 2.112676 | 111.1964 | 6.5 |
| 297 | 0.669344 | 6.678304 | 10 |
| 296 | 0.730897 | 6.397314 | 9 |
| 295 | 1.489362 | 7.792496 | 6 |
| 293 | 0.970874 | 17.75529 | 5 |
| 282 | 14.91819 | 21.58133 | 3 |
| 278 | 1.705238 | 30.41062 | 8 |
| 277 | 15.92852 | 35.57287 | 11 |
| 249 | 0.480769 | 11.32927 | 7 |
| 248 | 0.657895 | 11.30316 | 6 |
| 246 | 13.65082 | 20.55405 | 4 |
| 244 | 1.360544 | 26.96898 | 5 |
| 215 | 5.053947 | 42.20995 | 9 |
| 214 | 1.635992 | 13.09175 | 6 |
| 211 | 2.083333 | 37.58127 | 5 |
| 210 | 12.95337 | 28.02276 | 5 |
| 205 | 2.298851 | 31.92957 | 4.5 |
| 203 | 7.692308 | 80.82378 | 5 |
| 202 | 1.77665 | 38.35225 | 5.5 |
| 163 | 0.832342 | 13.49468 | 9.15 |
| 162 | 2.485876 | 16.69294 | 8 |
| 161 | 1.358234 | 15.82753 | 6.5 |
| 158 | 4.664076 | 12.57804 | 10.05 |
| 156 | 3.743316 | 8.860227 | 6 |
| 155 | 2.662722 | 18.1994 | 5 |
| 149 | 0.704225 | 12.89416 | 6 |
| 148 | 0.130293 | 12.61959 | 9 |
| 146 | 0.198807 | 6.199738 | 4.5 |
| 143 | 0.473373 | 6.624391 | 6.5 |
| 141 | 1.709402 | 39.55509 | 8 |
| 134 | 2.071006 | 23.70184 | 5 |
| 129 | 1.428571 | 10.8077 | 9.15 |
| 127 | 0.324675 | 27.94209 | 6.5 |
| 125 | 0.412371 | 7.731901 | 4.5 |

TABLE 2
Initial test data for online impression optimization method
without the use of programming module installed on the server

| | Positive | | Cost of |
|---|---|---|---|
| | Response | Response | Impression |
| Campaigns | Probability | Time | of 1000 Ads |
| Cmpld | Fillrate, % | AvgTTI | CPM |
| 277 | 15.92852 | 35.57287 | 11 |
| 314 | 2.561624 | 31.72821 | 10.5 |
| 158 | 4.664076 | 12.57804 | 10.05 |
| 297 | 0.669344 | 6.678304 | 10 |
| 163 | 0.832342 | 13.49468 | 9.15 |
| 129 | 1.428571 | 10.8077 | 9.15 |
| 346 | 0.554017 | 5.670418 | 9 |
| 334 | 0.2849 | 16.34028 | 9 |
| 329 | 5.342903 | 101.7084 | 9 |
| 296 | 0.730897 | 6.397314 | 9 |
| 215 | 5.053947 | 42.20995 | 9 |
| 148 | 0.130293 | 12.61959 | 9 |
| 328 | 0.462963 | 12.43471 | 8 |
| 318 | 3.663793 | 21.29013 | 8 |
| 313 | 0.958084 | 25.23443 | 8 |
| 278 | 1.705238 | 30.41062 | 8 |
| 162 | 2.485876 | 16.69294 | 8 |
| 141 | 1.709402 | 39.55509 | 8 |
| 300 | 0.151286 | 81.29928 | 7.5 |
| 345 | 0.160772 | 5.328465 | 7 |
| 327 | 2.479339 | 11.81878 | 7 |
| 249 | 0.480769 | 11.32927 | 7 |
| 339 | 35.22618 | 29.32446 | 6.5 |
| 298 | 2.112676 | 111.1964 | 6.5 |
| 161 | 1.358234 | 15.82753 | 6.5 |
| 143 | 0.473373 | 6.624391 | 6.5 |
| 127 | 0.324675 | 27.94209 | 6.5 |
| 312 | 3.441296 | 92.91185 | 6 |
| 295 | 1.489362 | 7.792496 | 6 |
| 248 | 0.657895 | 11.30316 | 6 |
| 214 | 1.635992 | 13.09175 | 6 |
| 156 | 3.743316 | 8.860227 | 6 |
| 149 | 0.704225 | 12.89416 | 6 |
| 202 | 1.77665 | 38.35225 | 5.5 |
| 299 | 1.388889 | 39.22976 | 5 |
| 293 | 0.970874 | 17.75529 | 5 |
| 244 | 1.360544 | 26.96898 | 5 |
| 211 | 2.083333 | 37.58127 | 5 |
| 210 | 12.95337 | 28.02276 | 5 |
| 203 | 7.692308 | 80.82378 | 5 |
| 155 | 2.662722 | 18.1994 | 5 |
| 134 | 2.071006 | 23.70184 | 5 |
| 205 | 2.298851 | 31.92957 | 4.5 |
| 146 | 0.198807 | 6.199738 | 4.5 |
| 125 | 0.412371 | 7.731901 | 4.5 |
| 246 | 13.65082 | 20.55405 | 4 |
| 282 | 14.91819 | 21.58133 | 3 |

TABLE 3
Initial test data for online impression optimization method
with the use of programming module installed on the server

| | Positive | | Cost of | |
|---|---|---|---|---|
| | Response | Response | Impression | |
| Campaigns | Probability | Time | of 1000 Ads | |
| Cmp Id | Fillrate, % | AvgTTI | CPM | Weight |
| 339 | 35.22618 | 29.32446 | 6.5 | 7.80816322 |
| 277 | 15.92852 | 35.57287 | 11 | 4.92548732 |
| 158 | 4.664076 | 12.57804 | 10.05 | 3.72665088 |
| 246 | 13.65082 | 20.55405 | 4 | 2.65657036 |
| 156 | 3.743316 | 8.860227 | 6 | 2.53491203 |
| 210 | 12.95337 | 28.02276 | 5 | 2.31122309 |
| 282 | 14.91819 | 21.58133 | 3 | 2.07376329 |
| 327 | 2.479339 | 11.81878 | 7 | 1.46845724 |
| 318 | 3.663793 | 21.29013 | 8 | 1.37671043 |
| 129 | 1.428571 | 10.8077 | 9.15 | 1.2094548 |
| 162 | 2.485876 | 16.69294 | 8 | 1.19134245 |
| 295 | 1.489362 | 7.792496 | 6 | 1.14676632 |
| 215 | 5.053947 | 42.20995 | 9 | 1.07760192 |
| 296 | 0.730897 | 6.397314 | 9 | 1.02825545 |
| 297 | 0.669344 | 6.678304 | 10 | 1.00226644 |
| 346 | 0.554017 | 5.670418 | 9 | 0.87932724 |
| 314 | 2.561624 | 31.72821 | 10.5 | 0.84773304 |
| 214 | 1.635992 | 13.09175 | 6 | 0.7497815 |
| 155 | 2.662722 | 18.1994 | 5 | 0.73154115 |
| 163 | 0.832342 | 13.49468 | 9.15 | 0.56436531 |
| 161 | 1.358234 | 15.82753 | 6.5 | 0.55779525 |
| 203 | 7.692308 | 80.82378 | 5 | 0.47586911 |
| 329 | 5.342903 | 101.7084 | 9 | 0.47278422 |
| 143 | 0.473373 | 6.624391 | 6.5 | 0.46448413 |
| 278 | 1.705238 | 30.41062 | 8 | 0.44859013 |
| 134 | 2.071006 | 23.70184 | 5 | 0.43688718 |
| 248 | 0.657895 | 11.30316 | 6 | 0.34922712 |
| 141 | 1.709402 | 39.55509 | 8 | 0.34572582 |
| 149 | 0.704225 | 12.89416 | 6 | 0.32769486 |
| 205 | 2.298851 | 31.92957 | 4.5 | 0.323989 |
| 313 | 0.958084 | 25.23443 | 8 | 0.30373866 |
| 328 | 0.462963 | 12.43471 | 8 | 0.29785206 |
| 249 | 0.480769 | 11.32927 | 7 | 0.29705206 |
| 211 | 2.083333 | 37.58127 | 5 | 0.27717704 |
| 293 | 0.970874 | 17.75529 | 5 | 0.27340415 |
| 202 | 1.77665 | 38.35225 | 5.5 | 0.25478492 |
| 244 | 1.360544 | 26.96898 | 5 | 0.25224239 |
| 125 | 0.412371 | 7.731901 | 4.5 | 0.24000171 |
| 312 | 3.441296 | 92.91185 | 6 | 0.22222974 |
| 345 | 0.160772 | 5.328465 | 7 | 0.21120604 |
| 299 | 1.388889 | 39.22976 | 5 | 0.17701982 |
| 334 | 0.2849 | 16.34028 | 9 | 0.15691898 |
| 146 | 0.198807 | 6.199738 | 4.5 | 0.1443015 |
| 298 | 2.112676 | 111.1964 | 6.5 | 0.12349675 |
| 148 | 0.130293 | 12.61959 | 9 | 0.09292196 |
| 127 | 0.324675 | 27.94209 | 6.5 | 0.07552719 |
| 300 | 0.151286 | 81.29928 | 7.5 | 0.0139564 |

Each option has been tried in 1000 experiments during development. The test results have shown that the server (401) with the above module is about twice as efficient. The efficiency assessment was based on reduction of TTE (Time to Event) and mean TOS (Time of Session). The TOS was used as the basis for campaign list generation (with/without module), the total TTE value of selected campaigns in the list didn't exceed the TOS value (the TTE values were summed up). As per Table 2, the ranking process without the above module has resulted in an advertising unit playback request list (campaigns to be polled) of first eight campaigns, shown in Table 2 (Campaign ID=277, 314, 158, 297, 163, 129, 346, 334). As per Table 3, the ranking process with the above module has resulted in an advertising unit playback request list of first eight campaigns, shown in Table 2 (Campaign ID=339, 277, 158, 246, 156, 210, 282, 327). The Weight value is the significance of specific campaign for specific advertising unit playback request basing on calculated Performance value and inversely proportional to it, i.e. Weight=1/Performance.

Thus, the disclosed method allows to eliminate the need of random search of campaigns or manual human assessment and increase server's (401) campaign selection accuracy (advertising unit playback responses) in response to incoming advertising unit playback requests from the Publisher. This means that implementation of the disclosed method on the server (401) with the use of the above module increases probability of finding a campaign that meets specific advertising unit playback request.

This advantage is based on comparing of number of playbacks against number of advertising unit playback requests for specific campaign in processing of a request. The playback rate set for specific campaign is also accounted for. While it follows from the formula that campaign's efficiency may remain unaffected even at a higher rate providing that the response speed (from the time the server (401) receives advertising unit playback request to the time the Advertiser (501) approves playbacks or issues an error) is higher in competing campaign while Advertiser's (501) FillRate value is lower. The disclosed method therefore considers the request response speed as another important factor as the request timeout, as has been mentioned earlier, is limited and can't be determined in advance which means that priority should be given to campaigns with higher response speed which list is completed basing on collected statistic and applicable empirical dependence.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

We claim:

1. A computer-implemented online advertising method, comprising:
receiving of advertising unit playback request data for one user's device by at least one server using a data exchange protocol that supports visual, audio, graphic and/or text information;
receiving of advertising unit playback response data containing advertising unit playback request selection criteria;
performing server-based comparison of advertising unit playback request data and received advertising unit playback request selection criteria;
generating server polling order for Advertiser software platforms from which advertising unit playback request data were sourced;
performing, at the server, polling of Advertiser software platforms from which advertising unit playback request data were sourced basing on generated polling order;
receiving of advertising unit playback confirmation data by server; and
performing playback of advertising unit on user's device for which a playback decision was made using data exchange protocol that supports visual, audio, graphic and/or text information.

2. The method of claim 1, further comprising
performing primary filtering of each advertising unit playback request basing on location of user's device and/or limit of the number of advertising unit playbacks for each Ad Placement and generation of a list of advertising unit playback request conforming location of user's device and limit of the number of advertising unit playbacks;
collecting by the server of advertising unit playback request data processing results, including total number of advertising unit playback requests, number of advertising unit playbacks (Impressions), and number of rejected advertising unit (Errors);
calculating performance for each advertising unit playback response against received request basing on the following equation:
Performance=TTE÷FillRate÷CPM,
wherein
Performance—ranking rate for specific advertising unit playback response;
TTE—time from ad response to the event, namely the event of advertising unit playback on user's device (Impression) or to the event of receiving of advertising unit playback rejection data on all processed server requests associated with specific advertising unit playback (Error);
FillRate—advertising unit playback/request ratio, CPM—cost of 1000 advertising unit playbacks, and the FillRate is calculated by the following equation:
FillRate=Impressions÷Requests,
ranking by the server of advertising unit playback responses basing on the Performance calculated above, from minimum ranking rate responses to maximum ranking rate responses;
performing playback of advertising unit on user's device for the response with the lowest ranking rate; and
performing playback of advertising unit with higher ranking rate response when the playback of advertising unit with previous ranking rate is rejected.

2. The method according to claim 1, wherein the results of processing of requests sent from the server to devices from which the advertising unit playback response data were received, include the following data: video player size, user's browser, user's operation system and/or location of user's device.

3. The method according to claim 1, wherein the results of processing of advertising unit playback requests collected by the server are sorted by time intervals, from the time the server has received advertising unit playback request data from user's device.

4. The method according to claim 3, wherein duration of the time intervals is selected from the group consisting of: 1, 5, 20, 60, 180 and 360 minutes.

5. The method according to claim 3, wherein when calculating ranking rate for each advertising unit playback response for received request, the specified data for the lowest time interval are used first followed by the data from the next time intervals providing that the amount of data is lower than the amount preset for the previous time interval.

6. The method according to claim 1, wherein receiving of advertising unit playback request data by the server and playback of advertising unit on user's device is made by the use of data exchange protocol, such as VAST or VPAID API framework.
